(19) United States
(12) Patent Application Publication
(10) Pub. No.: US 2011/0307327 A1
(43) Pub. Date: Dec. 15, 2011

(54) OPTIMIZATION OF CONSUMER OFFERINGS USING PREDICTIVE ANALYTICS

(75) Inventors: Todd Bixby, Maple Grove, MN (US); Yuri Smirnov, Palo Alto, CA (US); Gabriel J. Tavares, Denville, NJ (US)

(73) Assignee: FAIR ISAAC CORPORATION

(21) Appl. No.: 12/815,229

(22) Filed: Jun. 14, 2010

(51) Int. Cl. G06Q 30/00

(52) U.S. Cl. 705/14.43

(57) ABSTRACT

Data characterizing a population of consumers that is derived from history-based predictive analytics that describe expected outcomes for each of a plurality of offerings is used by a solver to solve an optimization problem. The solver identifies a subset of the population and assigns one or more of the plurality of offerings to be presented to consumers within the subset of the population while taking into account at least one constraint. Actions to be taken with the identified subset of the population in connection with the assigned one or more offering are then assigned so that at least a portion of the assigned actions can be initiated. Related apparatus, systems, techniques and articles are also described.

### TECHNICAL FIELD

The subject matter described herein relates to systems, methods, and articles that enable optimal offers to be provided to consumers based on a combination of predictive analytics and optimization.

### BACKGROUND

The effectiveness of traditional methods of advertising and promotional marketing through vehicles such as broadcast ads, print and other mass-marketing approaches are increasingly diminishing. The current retail business environment and consumer behavior shift to more advanced channels like smart phone, web 2.0, etc, has necessitated the movement of retailers away from the traditional methods of consumer marketing, forcing them to leverage more targeted and scaled ways of using new channels. In response to the aforementioned trends, retailers are implementing more sophisticated cross-channel offer management and optimization that are relevant to an individual consumer.

The ability to generate highly relevant and timely offers that scale to millions of customers, thousands of products, hundreds of stores with constantly changing inventory, thousands of suppliers that provide dynamic promotional investment, combined with consumers demanding to interact thru multiple channels at any given time, dramatically increases the complexity to manage and operationalize personalized offers. Traditional methods to accomplish this, would generate thousands of predictive models that becomes operationally ineffective. However, the solution outlined herin, provides the ability to efficiently manage trillions of possible combinations of the above parameters that yields resounding business results with improved customer satisfaction and improved business value for all constituents. Offers are optimized to enhance customer loyalty, raise response rates, improve revenue, increase margin, increase profit, increase share of wallet and increase shopping frequency.

### SUMMARY

From a process flow perspective, in one aspect, data that describes a customer population is derived through a combination of demographic, preference and transaction level detail at the customer level. Predictive analytics algorithms are then applied to this data, again at the customer level providing scores that predict the propensity to purchase certain items or products through specific channels within a specified timeframe. Thereafter, a solver is used to solve an optimization problem based upon the propensity scores. The solver identifies the best subset of the population to assign particular items to and then assigns one or more items to that consumer based upon additional constraints like available supplier funding, available channels, store-level item availability, etc.

The subject matter described herein provides many advantages. For example, the current subject matter provides a recommendation system that can characterize or suggest supplier funding commitment levels. This fundamental shift in business approach, allows the retailer and supplier to work together to secure the appropriate investment levels for promotions based upon predicted customer demand, which, in turn, improves customer loyalty and relevance.

The ROP application described below can, for example, serve a number of purposes. For example, it can not only efficiently generate an optimized set of recommendations for millions of customers in a timely manner, but could also be used to help suppliers/retailers set promotional budgets.

Additionally, the current subject matter is advantageous and extensible in that it does not only deal with a flat product hierarchy. The current subject matter also has the capability to deal with a multi-level cross-category hierarchy. This allows a complex set of decisioning to be imposed using brand, theme, genre and multiple sub-categories. Therefore, the multi-dimensional hierarchies are enabled, in which a product can belong to several structures. For example, a TV can be a large flat-screen LCD TV, SONY brand and belong to home entertainment genre. Such a multi-dimensional hierarchical organization of products supports creative rules and provides more refined controls over customer's behavioral patterns and is no longer restricted to a single product or single vendor funding.

Additionally, the subject matter described herein utilizes new multi-dimensional hierarchies introduced for retail products offering new creative ways to introduce and describe product eligibility (a Θ set of ineligible assignments). For example, if a person purchased an expensive item of a certain brand, (s)he is more likely to buy an accompanying product of the same brand. If a person bought a large-screen TV, this person is not eligible for a large-screen TV offer. In another example, if a customer does not have a baby between 0 and 4 years old, this person should not be offered baby diaper offers. Combining rules, if a person purchased a name brand gaming system, under certain limitations, this person may not be eligible for the same gaming offer; however, they would possibly be very interested in games that are specific to that gaming system. Such a multi-dimensional hierarchical product data model supports a variety of rules/constraints and corrections to the objective function, including offering a pre-defined multiplicity of items, themes and genres to customers

The current subject matter can be utilized to maximize the propensity of customer purchases over a large set of accounts or individuals for a given consumer for a given period of observed shopping behavior. With such an arrangement, the only flavor of the objective has been to maximize the sum of propensities calculated by the predictive analytics application based on the history of prior purchases. However, additional hierarchical product structures and new foci of optimization promote multi-criteria optimization can also be utilized as the objective function that switches between or combines propensity, revenue, margin, profit, normalization/corrections for brands, themes, genres, etc. Objective functions for multi-criteria optimization can be organized as a weighted sum or successive optimization runs with preceding objective values becoming part of constraint set for the optimization problem with a new objective function.

The details of one or more variations of the subject matter described herein are set forth in the accompanying drawings and the description below. Other features and advantages of the subject matter described herein will be apparent from the description and drawings, and from the claims.

### DESCRIPTION OF DRAWING

FIG. 1 is a process flow diagram illustrating a method of optimally assigning and initiating actions to a plurality of consumers.

### DETAILED DESCRIPTION

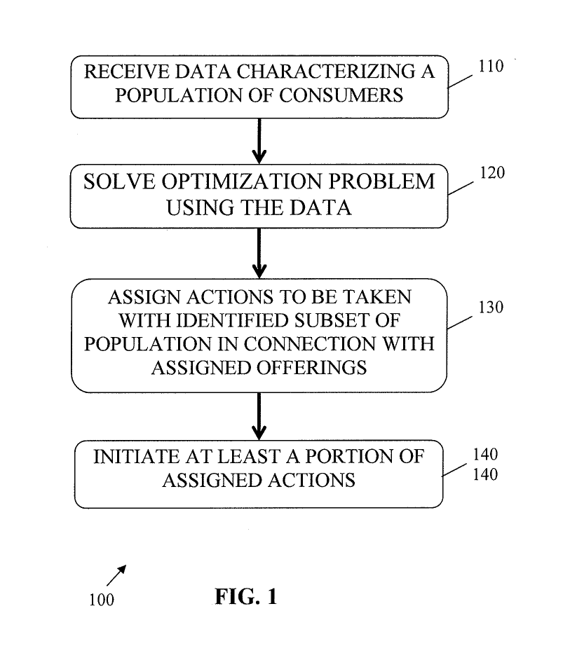

FIG. 1 is a process flow diagram illustrating a method 100, in which at 110, data characterizing a population of consumers is received. This data can be derived from history-based predictive analytics that describe expected outcomes for each of a plurality of offerings. Thereafter, at 120, a solver is used to solve an optimization problem based on the [which data]data. The solver identifies a subset of the population and assigns one or more of the plurality of offerings to be presented to consumers within the subset of the population while taking into account at least one constraint. Actions to be taken with the identified subset of the population in connection with the assigned one or more offering are, at 130, then assigned so that, at 140, at least a portion of the assigned actions can be initiated.

The data that characterizes the population of consumers can be obtained using a variety of history-based predictive analytics which use historical information (e.g., past transactions from consumers, etc.) in order to determine a likelihood of such consumers taking a later action. Such analytics can be based on predictive models (such as neural networks, support vector machines, etc.) that require training on historical data from a large population of consumers. Example systems and techniques for obtaining such data include the PEACOCK system from Fair Isaac Corporation and the subject matter described in U.S. Pat. No. 7,672,865 entitled: “Method and apparatus for retail data mining using pair-wise co-occurrence consistency” the contents of which are hereby fully incorporated by reference.

An analytics platform is described herein (referred to as Retail Action Manager (RAM)) that leverages predictive models and optimization to assign the best possible offers to a subset of a population. These offers can include, but are not limited to discounts, coupons, credit offers, invitations, product recommendations, and the like. As will be described in further detail below, the RAM platform can include a Recommendation OPtimization module (ROP) that can assign a set of optimal offers to a targeted population which, in a retail environment, refers to the delivery of offers to a set of customers who have a high propensity to purchase those products subject to a multiplicity of constraints (although references may be made to products, the skilled artisan will be appreciate that the current subject matter is also applicable to services and as such, references to products should not be limited in this regard). In this case, the objective value is to find the most relevant customer population and maximize the redemption rates for the offerings. ROP can produce product recommendations to consumers based on a fixed number of products, investment level given a certain known marketing channel (e.g. direct mail, email, SMS, etc.). ROP can be used in various other contexts, where there are multiple offers that could be made to a particular consumer, but where there are constraints like spam rules, investment levels, consumer preference, rewards versus holes-in-the-basket, credit history, etc. This includes other industries such as healthcare or financial Services.

The following describes a mathematical formulation of ROP within RAM, along with some basic features and properties. Lastly, variations are described to enhance performance from solvers and/or to create approximation (heuristic) models in order to increase the efficiency of the optimization module of RAM, while maintaining the quality of the results and the integrity of the analytic predictions. While the following is described primarily in connection with XPRESS solvers, it is plausible to utilize other solvers.

With regard to a mathematical formulation of ROP within a RAM platform, the following can be considered: a set of customers (or accounts) C, a set of products (Recommendations or treatments) P and a sequence of events S (or campaigns). For each customer cεC there is a known number of products R_{c} in the event Eₛ to be assigned to the customers that will receive recommendations. The contribution to the objective value of customer cεC of buying product pεP is denoted as W_{c,p,s}.

The ROP decision assignments can be denoted as for x_{c,p,s} every customer cεC and product pεP in the event s. The mathematical model returns x_{c,p,s}=1 if customer c gets product p as a recommendation in the event s, and returns x_{c,p,s}=0 otherwise. For every event s, the set of binary decisions can be represented as a two-dimensional matrix X whose row entries correspond to the customers and the column entries correspond to the products. A vector y of 0-1 decision variables about the choice of customers getting or not getting recommendations in the event s is also considered. Products P can be organized in hierarchies based on logistics sub-categories, brands, themes, genres that could share or vary the contribution toward the objective value, be used in additional restrictions and constraints.

The sequence of sets of assignments to be found by ROP is typically further reduced by restricting those assignments to occur within a certain linear decision space as a function of X and y, which will be denoted by Ω (sometimes called the Global Constraint set).

Usually Ω represents a linear decision space regarding the number of allowed choices for all the customers, products or segments or both. The decision space considered initially by ROP was

$$Ψ ≡ Ω ≡ {Ω}_{X} = \{ X ε {C \times P \times S}^{} \vert {\sum }_{s ε S} {\sum }_{c ε C} {x}_{c , p , s} \leq {V}_{p} , {\sum }_{s ε S} {\sum }_{c ε C} {x}_{c , p , s} \geq {M}_{p} , p ε P \} ,$$

where Vₚ represents the allowed number of recommendations (i.e. investment levels) for product pεP and Mₚ represents minimal commitment for product pεP. The constraints

$${\sum }_{s ∈ S} {\sum }_{c ∈ C} {x}_{c , p , s} \leq {V}_{p} , {\sum }_{s ∈ S} {\sum }_{c ∈ C} {x}_{c , p , s} \geq {M}_{p} ,$$

pεP are typically called the volume constraints or the investor commitment levels. These constraints can be based upon supplier funding, internal marketing budgets or overall budget numbers, or the like. In the problem of searching for recommended investment levels for suppliers, these volume constraints can be modified.

Usually there are additional eligibility/ineligibility restrictions that can be represented as an ineligibility set Θ and modeled as a set of constraints. These restrictions can be based on historic data and characterize the nature of shopping experience of every customer. They are often organized as brand, theme, genre, sub-category restrictions or ineligibility of specific products (e.g. never give a PEPSI offer to a repeated COKE buyer, do not offer large screen TV at least 3 months after a purchase of a big screen TV, etc.).

Usually there are exclusivity relations between items from the same brand, theme, genre or sub-category. Whereas the most common behavior is to limit to at most one offer from the sub-category, this constraint can be generalized to at most k items from several sub-categories.

The general mathematical formulation of ROP can then be described as follows:

$$max {\sum }_{s ε S} {\sum }_{c ε C} {\sum }_{p ε P} {F}_{c , p} {x}_{c , p , s}$$

subject to: (ROP-General

$$\begin{matrix} {\sum }_{p ε P} {x}_{c , p , s} \leq {R}_{c} {y}_{c , s} , & s ∈ S , c ∈ C \\ {x}_{c , p , s} = 0 & ∀ ( c , p , s ) ∈ ( C \times P \times S ) ⋂ Θ \\ X , y ∈ Ω ⋂ {\{ 0 , 1 \}}^{( \vert C \vert + 1 ) \times \vert P \vert \times \vert S \vert} & \end{matrix}$$

where F_{c,p} represents coefficients in the objective function. It can be the propensity W_{c,p}, or sales W_{c,p}*Cost_{c,p}, or profit W_{c,p}*M arg in_{c,p}, other objective functions or a weighted mix of several objective functions. Multi-dimensional hierarchies can have adjusting coefficients for products that belong to certain brands, themes, genres, sub-categories. Additional optimization features can be added to the ROP model to solve ROP problem with multiple criteria.

(ROP-General Formulation) is a 0-1 Linear Programming (LP) problem and consequently can be solved by a Mixed Integer Programming solver (like XPRESS). 0-1 LP is a NP-hard problem in general, which is an indication that there has not been found a process of finding an optimal solution to problems like (ROP-General Formulation) that take less than exponentially long time, as a function of its input size (i.e. in the number of customers or products). However, some of the solvers like XPRESS can efficiently solve 0-1 LP problems of very large size.

The following sections investigate some properties of the problem (ROP-General Formulation) and its particular cases.

The following case using Ω≡Ψ will be called (ROP-Basic):

$$max {\sum }_{s ε S} {\sum }_{c ε C} {\sum }_{p ε P} {F}_{c , p} {x}_{c , p , s}$$

subject to: (ROP-Basic)

$$\begin{matrix} {\sum }_{p ∈ P} {x}_{c , p , s} \leq {R}_{c} {y}_{c , s} , & s ∈ S , c ∈ C \\ {\sum }_{s ∈ S} {\sum }_{c ∈ C} {x}_{c , p , s} \leq {V}_{p} , & p ∈ P \\ {\sum }_{s ∈ S} {\sum }_{c ∈ C} {x}_{c , p , s} \geq {M}_{p} , & p ∈ P \\ {x}_{c , p , s} = 0 , & ( c , p , s ) ∈ C \times P \times S ⋂ Θ \\ {x}_{c , p , s} ∈ \{ 0 , 1 \} , & c ∈ C , p ∈ P , s ∈ S \\ {y}_{c , s} ∈ \{ 0 , 1 \} , & c ∈ C , s ∈ S\end{matrix}$$

(ROP-Basic) considers a Θ set of ineligible assignments introduced through a list of ineligible matching of customers c with either a lower-level product p or a higher level brand, theme, genre, sub-category. If product, brand, theme or genre p cannot be recommend to customer c, then x_{c,p,s}=0.

A Recommendation Investor Level (RIL) problem can be also modeled as a Mixed Integer Programming (MIP) problem. The purpose of the RIL solution is to determine recommended investor commitments over a span of multiple campaigns or timeframes to attain the either the highest revenue, margin, profit (product, customer, overall), customer satisfaction or other business metrics. The RIL problem is somewhat similar to ROP feasibility region, but a different objective function.

$$max ( {\sum }_{s ε S} {\sum }_{c ε C} {\sum }_{p ε P} {G}_{c , p , s} {x}_{c , p , s} - {\sum }_{p ε P} {C}_{p} {z}_{p} )$$

subject to: (RIL-Basic)

$$\begin{matrix} {\sum }_{p ∈ P} {x}_{c , p , s} \leq {R}_{c} {y}_{c , s} , & s ∈ S , c ∈ C \\ {\sum }_{s ∈ S} {\sum }_{c ∈ C} {x}_{c , p , s} \leq {z}_{p} , & p ∈ P \\ {x}_{c , p , s} = 0 & ∀ ( c , p , s ) ∈ ( C \times P \times S ) ⋂ Θ \\ Z ∈ & \\ X , y ∈ Ω ⋂ {\{ 0 , 1 \}}^{( \vert C \vert + 1 ) \times \vert P \vert \times \vert S \vert} & \end{matrix}$$

where G_{c,p,s} is a revenue/profit/margin coefficient directly related to each recommendation x_{c,p,s}, Cₚ is the cost associated with a unit measure of commitment level, Ξ is a linear space of considered supplier investment levels.

More refined formulations of the RIL problem can be worked out along the lines of the ROP formulations. ROP and RIL share a lot in common. Due to the similarity of two models from the mathematical point of view, the subject matter described herein emphasizes the ROP model (and the skilled artisan will appreciate how the current subject matter can be applied to RIL). The main difference between ROP and RIL is with regard to business perspective. Namely, the RIL model converts reactive behavior of the RAM application from a reactive solution (e.g. things to offer customers based upon current constraints) into a proactive environment whereby the platform can predict into some future time t, which products or offers that should be made to customers. With such an arrangement, the retailer can now go to its suppliers and tell them here are the products, the investment levels and the timeframe for each and every product/customer.

In one implementation ROP and RIL can be combined.

With ROP, all decisions can be binary (i.e. recommend/not recommend), and consequently the underlying problem can be considered as a pure 0-1 linear optimization problem.

The number of decision variables of (ROP-General Formulation) is |S|·|P|·(|C|+1).

Let us suppose that the Global Constraints set that defined Ω is denoted as G. Then the number of constraints of (ROP-General Formulation) is |C|+|G|, of which |C| are inequality constraints.

In what follows we shall consider the continuous extension

$$max {\sum }_{s ε S} {\sum }_{c ε C} {\sum }_{p ε P} {F}_{c , p} {x}_{c , p , s}$$

subject to: (ROP-General*)

$$\begin{matrix} {\sum }_{p ∈ P} {x}_{c , p , s} \leq {R}_{c} {y}_{c , s} , & s ∈ S , c ∈ C \\ {x}_{c , p , s} = 0 & ∀ ( c , p , s ) ∈ ( C \times P \times S ) ⋂ Θ \\ X , y ∈ {Ω [ 0 , 1 ]}^{( \vert C \vert + 1 ) \times \vert P \vert \times \vert S \vert} & \end{matrix}$$

of (ROP-General Formulation), obtained by relaxing the integrality of the 0-1 decision variables to the continuous interval [0,1]. The relaxed problem is frequently called as the relaxation. Let us denote the optimal objective of (ROP-General Formulation) as z_{I} and the optimal objective of its relaxation (ROP-General*) as z_{C}. Clearly, the optimal objective of the relaxation infers an upper bound on the optimum value of (ROP-General Formulation), i.e. z_{I}≦z_{C}.

In practice the number of global constraints in ROP is small with respect to the number of customers |C| and the number of products |P|. In the (ROP-Basic) case, |G|=|P|+|Ω|. The relaxation of (ROP-Basic) can be re-formulated to the canonical LP form as follows:

$$max {\sum }_{s ε S} {\sum }_{c ε C} {\sum }_{p ε P} {F}_{c , p} {x}_{c , p , s}$$

subject to: (ROP-Basic-Standard)

$$\begin{matrix}{\sum }_{p ∈ P} {x}_{c , p , s} + {t}_{c , s} = {R}_{c} {y}_{c , s} , & c ∈ C , s ∈ S \\ {\sum }_{s ∈ S} {\sum }_{c ∈ C} {x}_{c , p , s} + {s}_{p} = {V}_{p} , & p ∈ P \\ {x}_{c , p , s} = 0 , & ( c , p , s ) ∈ C \times P \times S ⋂ Θ \\ {x}_{c , p , s} + {\overline{x}}_{c , p , s} = 1 , & c ∈ C , p ∈ P , s ∈ S \\ {y}_{c , s} + {\overline{y}}_{c , s} = 1 , & c ∈ C , s ∈ S \\ {x}_{c , p , s} , {\overline{x}}_{c , p , s} \geq 0 , & c ∈ C , p ∈ P , s ∈ S \\ {y}_{c , s} , {\overline{y}}_{c , s} \geq 0 , & c ∈ C , s ∈ S \\ {t}_{c , s} \geq 0 , & c ∈ C , s ∈ S \\ {s}_{p} \geq 0 , & p ∈ P\end{matrix}$$

(ROP-Basic-Standard) is a Mixed Integer Problem (MIP) obtained from (ROP-Basic) by introducing slack variables (t_{c,s}, cεC, sεS) to the mailing per account constraints and (sₚ, pεP) to the volume constraints. It is always feasible since the solution y_{c,s}=x_{c,p},s=0, for all cεC, pεP, sεS is a feasible solution, which represents the case of not recommending any product to any customer.

The number of constraints of (ROP-Basic-Standard) is 2|C|·|S|+|P|+|C|·|P|·|S| and the number of variables is 2|C|·|S|+|P|+2|C|·|P|·|S|. From the theory of linear optimization, the relaxation of (ROP-Basic-Standard) has an optimal Basic Feasible Solution (BFS) consisting of 2|C|·|S|+|P|+|C|·|P|·|S| variables. It is well known that all the non-Basic |C|·|P|·|S| variables must have a 0 value for any LP in canonical form. Due to the equalities x_{c,p,s}+ x̅_{c,p,s}=1 (cεC, pεP, sεS) and due to the large number of non-Basic variables involving variables in those equations then many of the basic variables have a value of 1.

In practice, (ROP-General*) returns a solution that is almost coincident with an integral point, and when a customer gets fully selected (i.e. y_{c,s}=1) then he will get R_{c} recommendations, on a typical case. These results indicate that those customers selected by the LP relaxation, in many cases will also be part of the (ROP-General Formulation) optimal solutions.

A heuristic approach to solve (ROP-General Formulation) is therefore:

$$max {\sum }_{s ε S} {\sum }_{c ε C} {\sum }_{p ε P} {F}_{c , p} {x}_{c , p , s}$$

subject to: (ROP-Heuristic)

$$\begin{matrix} {\sum }_{p ∈ P} {x}_{c , p , s} \leq {R}_{c} {y}_{c , s} , & c ∈ C , s ∈ S \\ {\sum }_{s ∈ S} {\sum }_{c ∈ C} {x}_{c , p , s} \leq {V}_{p} , & p ∈ P , s ∈ S \\ {\sum }_{s ∈ S} {\sum }_{c ∈ C} {x}_{c , p , s} \geq {M}_{p} , & p ∈ P , s ∈ S \\ {x}_{c , p , s} = 0 , & ( c , p , s ) ∈ C \times P \times S ⋂ Θ \\ {x}_{c , p , s} ∈ \{ 0 , 1 \} , & c ∈ C , p ∈ P , s ∈ S \\ {y}_{c , s} ∈ \{ 0 , 1 \} , & c ∈ ( C \backslash {C}^{*} ) \times S \\ {y}_{c , s} = 1 , & c ∈ {C}^{*} \times S\end{matrix}$$

where C* is the set of customers fully selected in (ROP-General*), i.e. those customers having a solution of y_{c,s}=1. Let us denote the optimal objective value of (ROP-Heuristic) as z_{H}. Clearly, z_{H}≦z_{I}≦z_{R}.

Model formulation (ROP-Heuristic) has been implemented using XPRESS-Mosel. The business constraints considered by ROP are the following:
(i) Volume Constraint—There are maximum and minimum investment levels allowed for each individual product across the matching (i.e. constraint set Σ_{cεC}x_{c,p}≦Vₚ and Σ_{cεC}x_{c,p}≧Mₚ and for all pεP);
(ii) Ineligibility Constraint—Certain products (brands, themes, genres, sub-categories) have been determined as ineligible for some customers, as well as a corresponding set of choices/decisions (x_{c,p,s}=0 ∀(c,p,s)εC×P×S∩Θ);
(iii) Exclusivity Rules—New product hierarchies support better expressiveness in the inclusion/exclusion rules. For example, for certain sub-categories a selection of product p* for any customer cεC excludes all products belonging to the same sub-category as product p* and cannot be recommended to customer

$$c ( {\sum }_{s ∈ S} {\sum }_{c ∈ C} {\sum }_{p ∈ SC} {x}_{c , p , s} \leq 1 ) ,$$

this exclusivity constraint can be relaxed to have a different right-hand side for the entire campaign, say 3, or a varying right-hand side

$${\sum }_{s ∈ S} {\sum }_{c ∈ C} {\sum }_{p ∈ SC} {x}_{c , p , s} \leq {H}_{p}$$

per product, brand, theme, genre, sub-category or

$${\sum }_{s ∈ S} {\sum }_{c ∈ C } {\sum }_{p ∈ SC} {x}_{c , p , s} \leq {H}_{p , s}$$

per product/brand/theme/genre/sub-category and campaign;
(iv) Bottom-Fishing Constraint—Certain customer choices are forbidden for those products where a customer has a low rank in the product scores distribution. These constraints can also be implemented using eligibility/ineligibility constraints. The current model has a more general related constraint that allows a user to receive a (prescribed) maximum number of low rank scores.

One or more of the constraints (i-iv) can be provided to ROP as user inputs. In some cases the inputs can be read directly from the database, in other cases are assigned as text files, and some are provided as runtime control parameters. These options are described in the following section.

Mosel language used in XPRESS models utilizes a set of strings to represent the set of customers (resp. products). Each string in this set uniquely identifies the customer (resp. products).

In the following files definitions, if a field/value is defined as having the string type, then their value in the (text) file needs to be included between single quotes.

The scores are inputted into Mosel model as a normalized, tabular list of values through the use of a pipe-delimited text file. First column of the table has accounts, second column contains products/sub-categories, the scores associated with a product/sub-category for every customer are in the third column.

The top row of the matrix is an optional header, which identifies the columns. Table 1 shows an example of the scores file.

TABLE 1
Scores file having two products and two customers.

‘customer’|‘Product Subcats’|‘Scores’
‘000152908296065000’|‘008296065000’|0.07919
‘000294380129874000’|‘008296065000’|0.011892
‘000294380129874000’|‘008296065001’|0.013434

The list of customers with eligible/ineligible choices of products is inputted into Mosel as a sparse normalized list of triples or quadruples in a delimited text file. First column has the customer ID, second column contains the product sub-category reference, third optional column has the product reference and last column contains a number, which is used to differentiate between eligibility, ineligibility and other specific purposes, say rewards versus hole-in-the-basket types.

The top optional row of the file is the header, which identifies the various columns of the eligibility data.

TABLE 2
Eligibility matrix for 2 product sub-categories,
4 products and 2 customers.

‘customer’|‘Product Subcat’|‘Product’|‘Eligibility Code’
‘000152908296065000’|‘008296065000’|‘0056567065011’|−1
‘000152908296065000’|‘008296065000’|‘0056567065012’|−1
‘000152908296065001’|‘008296067000’|‘0056567067011’|−1
‘000152908296065001’|‘008296067000’|‘0056567067012’|−1

ROP assumes that only customers with eligible choices will be allowed to be selected. Customer with identifier ‘000152908296065000’ has scores defined (see Table 1) but will be not be selected to receive recommendations for products ‘0056567065011’ and ‘0056567065012’ from sub-category ‘008296065000’ according to the above eligibility file, because −1 is the ineligibility code.

There is no particular order assumed by ROP both for the sets of products or customers.

The maximum allowed investment levels required for each product can be inputted into Mosel model as a dense matrix of values through the use of a delimited text file. Each column of the matrix has the investment levels associated to a given campaign for every product, plus a reference to the product sub-category is introduced too to tie investment levels on the level of products/items to scores on the level of product sub-categories. Each row of the matrix (except the optional header row) has the maximum product recommendations allowed for a given campaign.

The top row of the matrix is an optional header, which identifies the various campaigns. Table 3 shows an example of the volume file.

TABLE 3
Volume file for two campaigns, two product
sub-categories and four products.

‘Product Subcat’|‘Product’|‘Campaign A’|‘Campaign B’
‘008296065000’|‘0056567065011’|10000|0
‘008296065000’|‘0056567065012’|5000|4000
‘008296067000’|‘0056567067011’|10000|0
‘008296067000’|‘0056567067012’|5000|4000

ROP only considers products having a positive investment on some campaign. In the previous example ‘0056567065011’ and ‘0056567067011’ items will be disregarded in the ROP model for Campaign B.

Minimum volume data is introduced through a mirror volume file of the same format. If the minimum requirement is 0 for any product-campaign combination, it is ignored.

The purpose of the exclusions file is to instruct ROP that can only select at most one product given within a set of substitute products. The input file is a delimited file that specifies the list of mutually exclusive sets of products. Each row contains the description of a given set. The first entry of the row is the size of the set. The following entries contain the product members of the set. Table 4 shows an example of the exclusions file.

TABLE 4
Mutual products exclusion file for two mutually exclusive sets.

2|‘0056567065011’|‘0056567065012’
3|‘0056567067011’|‘0056567067012’|‘0056567067013’

The output file containing the customer recommendations is a pipe-delimited file. Each row corresponds to a customer-recommended product pairs accompanied with the number of pre-defined parameters for a seamless upload into a database table. For the 2.0 priority numbers and scores are added to facilitate post-optimization analysis and possible product substitutions. Table 5 shows an example of the output file.

TABLE 5
Example of the output file, containing two
customers recommended two products each.

118700012|‘000152908296065000’|43500401|2009-12-17|NULL|2009-12-17

14:06:04|BBY_BATCH|2009-12-17 14:06:04|BBY_BATCH|9625208

118700013‘000152908296065000’|3605808|2009-12-17|NULL|2009-12-17

14:06:04|BBY_BATCH|2009-12-17 14:06:04|BBY_BATCH|9365652

118700012|‘000152908296065001’|43500401|2009-12-17|NULL|2009-12-17

14:06:04|BBY_BATCH|2009-12-17 14:06:04|BBY_BATCH|9625208

118700013‘000152908296065001’|3605808|2009-12-17|NULL|2009-12-17

14:06:04|BBY_BATCH|2009-12-17 14:06:04|BBY_BATCH|9365652

In practice the current version of XPRESS can handle ROP problems efficiently, if |C|·|P|≦10,000,000. Depending on the global constraints and the objective function employed, in certain cases XPRESS would be able to handle problems having |C|·|P|≦50,000,000 (assuming that there is enough RAM memory available). The size of the largest ROP problem that XPRESS can solve within a time limit will also depend on whether a heuristic or an exact approach is considered. In some implementations, implied bound cuts can be used to improve the speed of the ROP results. This family of cuts is also extremely important to be able to solve larger scale models.

The algorithm considered to solve the LP relaxation of ROP can be either the simplex Dual or the Barrier algorithm of XPRESS. Barrier is typically better for the very large ROP models, whereas the Dual method is typically better for medium and small ROP models. For the Dual algorithm it is recommended to use the control DUALGRADIENT=3, which controls the pricing algorithm of the simplex method and results in practical computing time gains, when compared to the default pricing mechanism.

The current approach is based on XPRESS-Mosel, which is a high level modeling and programming language. With this interface, the Optimizer expert will be able to incorporate a new business rule or a new objective function in a few hours of work on a typical case. This type of interface is very flexible for rapid prototyping or for “what-if” scenarios generation. When adopting XPRESS-Mosel, the only concern to be aware of is the fact that Mosel requires extra memory to handle the high level data structures. If memory becomes a bottleneck for ROP, then the XPRESS-Optimizer library should be considered instead of the XPRESS-Mosel interface. However, the XPRESS-Optimizer library will require substantially longer development time than Mosel, in the case a change in the model would be required.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. An article of manufacture comprising computer executable instructions non-transitorily stored on computer readable media, which, when executed by a computer, causes the computer to perform operation comprising:
receiving data characterizing a population of consumers, the data derived from history-based predictive analytics that describe expected outcomes for each of a plurality of offerings;
using a solver to solve an optimization problem using the data, the solver identifying a subset of the population and assigning one or more of the plurality of offerings to be presented to consumers within the subset of the population while taking into account at least one constraint;
assigning actions to be taken with the identified subset of the population in connection with the assigned one or more offering; and
initiating at least a portion of the assigned actions.

2. An article as in claim 1, wherein the offerings relate to retail products or services.

3. An article as in claim 1, wherein the history-based predictive analytics are derived from historical retail purchases from each consumer using a predictive model trained from historical retail transactions from a plurality of consumers.

4. An article as in claim 1, wherein the solver is a mixed integer programming solver.

5. An article as in claim 4, wherein the optimization problem is a pre-defined linear programming problem.

6. An article as in claim 1, wherein the at least one constraint includes a volume constraint that defines maximum and minimum investment levels for the one or more offerings across the subset of the population.

7. An article as in claim 6, wherein the at least one constraint includes an ineligibility constraint that defines which offerings and/or decisions have been determined as ineligible for certain consumers within the subset of the population.

8. An article as in claim 1, wherein the assigned actions are restricted to a decision space.

9. An article as in claim 8, wherein the decision space is a linear decision space and the restriction is as a function of Ω, wherein:
$$Ψ ≡ Ω ≡ {Ω}_{x} = \{ X ∈ {C \times P \times S}^{} \vert {\sum }_{s ∈ S} {\sum }_{c ∈ C} {x}_{c , p , s} \leq {V}_{p} , {\sum }_{s ∈ S} {\sum }_{c ∈ C} {x}_{c , p , s} \geq {M}_{p} , p ∈ P \} ,$$
wherein:
C characterizes a set of consumers,
P characterizes a set of offerings, and
S characterizes a sequence of events.

10. An article as in claim 9, wherein for each consumer cεC there is a known number of products R_{c} in the event Eₛ is to be assigned to the consumers that will receive the at least one offering.

11. An article as in claim 10, wherein a contribution to an objective value of customer cεC of buying product pεP is denoted as W_{c,p,s}.

12. An article as in claim 11, wherein decision assignments are denoted as x_{c,p,s} for every customer cεC and product pεP in the event s.

13. An article as in claim 12, wherein x_{c,p,s}=1 if customer c gets product p as a recommendation in the event s, and returns x_{c,p,s}=0 otherwise.

14. An article as in claim 13, wherein for every event s, a set of binary decisions can be represented as a two-dimensional matrix X whose row entries correspond to the consumers and column entries correspond to the offerings.

15. An article as in claim 14, wherein a vector y of 0-1 decision variables about a choice of consumers being assigned the at least one offering in the event s is also considered.

16. An article as in claim 15, wherein products P are organized in hierarchies based on factors that can share or vary a contribution toward the objective value.

17. An article as in claim 16, wherein Vₚ represents an allowed number of recommendations for product pεP,
Mₚ represents minimal commitment for product pεP, and
constraints
$${\sum }_{s ∈ S} {\sum }_{c ∈ C} {x}_{c , p , s} \leq {V}_{p} , {\sum }_{s ∈ S} {\sum }_{c ∈ C} {x}_{c , p , s} \geq {M}_{p} ,$$
pεP characterize volume constraints or investor commitment levels.

18. An article as in claim 1, wherein the optimization problem is defined by:
$$max {\sum }_{s ε S} {\sum }_{c ε C} {\sum }_{p ε P} {F}_{c , p} {x}_{c , p , s}$$
subject to:
$$\begin{matrix} {\sum }_{p ∈ P} {x}_{c , p , s} \leq {R}_{c} {y}_{c , s} , & s ∈ S , c ∈ C \\ {x}_{c , p , s} = 0 & ∀ ( c , p , s ) ∈ ( C \times P \times S ) ⋂ Θ \\ X , y ∈ Ω ⋂ {\{ 0 , 1 \}}^{( \vert C \vert + 1 ) \times \vert P \vert \times \vert S \vert} & \end{matrix}$$
wherein:
C characterizes a set of consumers,
P characterizes a set of offerings,
S characterizes a sequence of events,
F_{c,p} represents coefficients in an objective function,
Θ represents ineligibility restrictions,

19. An article as in claim 18, wherein the objective function can pertain to one or more of propensity W_{c,p}, or sales W_{c,p}*Cost_{c,p}, or profit W_{c,p}*M arg in_{c,p}.

20. An article as in claim 18, wherein the objective function comprises a weighted mix of several objection functions.

21. An article as in claim 18, wherein:
Ω≡Ψ, and
$$max {\sum }_{s ε S} {\sum }_{c ε C} {\sum }_{p ε P} {F}_{c , p} {x}_{c , p , s}$$
subject to:
$$\begin{matrix} {\sum }_{p ∈ P} {x}_{c , p , s} \leq {R}_{c} {y}_{c , s} , & s ∈ S , c ∈ C \\ {\sum }_{s ∈ S} {\sum }_{c ∈ C} {x}_{c , p , s} \leq {V}_{p} , & p ∈ P \\ {\sum }_{s ∈ S} {\sum }_{c ∈ C} {x}_{c , p , s} \geq {M}_{p} , & p ∈ P \\ {x}_{c , p , s} = 0 , & ( c , p , s ) ∈ C \times P \times S ⋂ Θ \\ {x}_{c , p , s} ∈ \{ 0 , 1 \} , & c ∈ C , p ∈ P , s ∈ S \\ {y}_{c , s} ∈ \{ 0 , 1 \} , & c ∈ C , s ∈ S\end{matrix}$$
which considers a Θ set of ineligible assignments introduced through a list of ineligible matching of customers c with either a lower-level product p or a higher level brand, theme, genre, sub-category and if product p cannot be recommend to consumer c, then x_{c,p,s}=0.

22. An article as in claim 1, wherein the problem is used to determine recommended investor commitments over a span of multiple campaigns or timeframes to attain an optimal metric.

23. An article as in claim 1, wherein the metrics includes: highest revenue, margin, profit overall, profit by product, product by consumer, and consumer satisfaction.

24. An article as in claim 1, wherein the problem is defined by:
$$max ( {\sum }_{s ε S} {\sum }_{c ε C} {\sum }_{p ε P} {G}_{c , p , s} {x}_{c , p , s} - {\sum }_{p ε P} {C}_{p} {z}_{p} )$$
subject to:
$$\begin{matrix} {\sum }_{p ∈ P} {x}_{c , p , s} \leq {R}_{c} {y}_{c , s} , & s ∈ S , c ∈ C \\ {\sum }_{s ∈ S} {\sum }_{c ∈ C} {x}_{c , p , s} \leq {z}_{p} , & p ∈ P \\ {x}_{c , p , s} = 0 & ∀ ( c , p , s ) ∈ ( C \times P \times S ) ⋂ Θ \\ Z ∈ & \\ X , y ∈ Ω ⋂ {\{ 0 , 1 \}}^{( \vert C \vert + 1 ) \times \vert P \vert \times \vert S \vert} & \end{matrix}$$
wherein:
C characterizes a set of consumers,
P characterizes a set of offerings,
S characterizes a sequence of events,
G_{c,p,s} is a revenue/profit/margin coefficient directly related to each recommendation x_{c,p,s},
Cₚ is a cost associated with a unit measure of commitment level, and
Ξ is a linear space of considered supplier investment levels.

25. An article as in claim 1, wherein the problem is defined as:
$$max {\sum }_{s ε S} {\sum }_{c ε C} {\sum }_{p ε P} {F}_{c , p} {x}_{c , p , s}$$
subject to:
$$\begin{matrix} {\sum }_{p ε P} {x}_{c , p , s} \leq {R}_{c} {y}_{c , s} , & s ε S , c ε C \\ {x}_{c , p , s} = 0 & ∀ ( c , p , s ) ε ( C \times P \times S ) ⋂ Θ \\ X , y ε Ω ⋂ {[ 0 , 1 ]}^{( \vert C \vert + 1 ) \times \vert P \vert x \vert S \vert} & \end{matrix}$$
wherein:
C characterizes a set of consumers,
P characterizes a set of offerings,
S characterizes a sequence of events, and
a number of decision variables is equal to |S|·|P|·(|C|+1).

26. An article as in claim 1, wherein the problem is defined as:
$$\begin{matrix} max {\sum }_{s ∈ S} {\sum }_{c ∈ C} {\sum }_{p ∈ P} {F}_{c , p} {x}_{c , p , s} & \\ { \sum }_{ p ∈ P} {x}_{c , p , s} + {t}_{c , s} = {R}_{c} {y}_{c , s} , & c ∈ C , s ∈ S \\ { \sum }_{s ∈ S} {\sum }_{c ∈ C} {x}_{c , p , s} + {s}_{p} = {V}_{p} , & p ∈ P \\ {x}_{c , p , s} = 0 , & ( c , p , s ) ∈ C \times P \times S ⋂ Θ \\ {x}_{c , p , s} + {\overline{x}}_{c , p , s} = 1 , & c ∈ C , p ∈ P , s ∈ S \\ subject to \text{:} {y}_{c , s} + {\overline{y}}_{c , s} = 1 , & c ∈ C , s ∈ S \\ {x}_{c , p , s} , {\overline{x}}_{c , p , s} \geq 0 , & c ∈ C , p ∈ P , s ∈ S \\ {y}_{c , s} , {\overline{y}}_{c , s} \geq 0 , & c ∈ C , s ∈ S \\ {t}_{c , s} \geq 0 , & c ∈ C , s ∈ S \\ {s}_{p} \geq 0 , & p ∈ P\end{matrix}$$
wherein:
C characterizes a set of consumers,
P characterizes a set of offerings, and
S characterizes a sequence of events.

27. An article as in claim 1, wherein the problem is defined as:
$$max {\sum }_{s ∈ S} {\sum }_{c ∈ C} {\sum }_{p ∈ P} {F}_{c , p} {x}_{c , p , s}$$
subject to:
$$\begin{matrix} {\sum }_{p ε P} {x}_{c , p , s} + {t}_{c , s} = {R}_{c} {y}_{c , s} , & c ε C , s ε S \\ {\sum }_{s ε S} {\sum }_{c ε C} {x}_{c , p , s} + {s}_{p} = {V}_{p} , & p ε P \\ {x}_{c , p , s} = 0 , & ( c , p , s ) ε C \times P \times S ⋂ Θ \\ {x}_{c , p , s} + {\overline{x}}_{c , p , s} = 1 , & c ε C , p ε P , s ε S \\ {y}_{c , s} + {\overline{y}}_{c , s} = 1 , & c ε C , s ε S \\ {x}_{c , p , s} , {\overline{x}}_{c , p , s} \geq 0 , & c ε C , p ε P , s ε S \\ {y}_{c , s} , {\overline{y}}_{c , s} \geq 0 , & c ε C , s ε S \\ {t}_{c , s} \geq 0 , & c ε C , s ε S \\ {s}_{p} \geq 0 , & p ε P\end{matrix}$$
wherein:
C characterizes a set of consumers,
P characterizes a set of offerings, and
S characterizes a sequence of events.

28. An article as in claim 1, wherein the problem is defined as:
$$max {\sum }_{s ε S} {\sum }_{c ε C} {\sum }_{p ε P} {F}_{c , p} {x}_{c , p , s}$$
subject to:
$$\begin{matrix} {\sum }_{p ε P} {x}_{c , p , s} \leq {R}_{c} {y}_{c , s} , & c ε C , s ε S \\ {\sum }_{s ε S} {\sum }_{C ε C} {x}_{c , p , s} \leq {V}_{p} , & p ε P , s ε S \\ {\sum }_{s ε S} {\sum }_{c ε C} {x}_{c , p , s} \geq {M}_{p} , & p ε P , s ε S \\ {x}_{c , p , s} = 0 , & ( c , p , s ) ε C \times P \times S ⋂ Θ \\ {x}_{c , p , s} ε \{ 0 , 1 \} , & c ε C , p ε P , s ε S \\ {y}_{c , s} ε \{ 0 , 1 \} , & c ε ( C \backslash {C}^{*} ) \times S \\ {y}_{c , s} = 1 , & c ε {C}^{*} \times S\end{matrix}$$
wherein:
C characterizes a set of consumers,
P characterizes a set of offerings, and
S characterizes a sequence of events.
